(19) United States
(12) Patent Application Publication
(10) Pub. No.: US 2014/0350967 A1
(43) Pub. Date: Nov. 27, 2014

(54) SYSTEM AND METHOD FOR PRIORITIZING RISK MODELS AND SUGGESTING SERVICES BASED ON A PATIENT PROFILE

(71) Applicant: KONINKLIJKE PHILIPS N.V., EINDHOVEN (NL)

(72) Inventors: Gijs Geleijnse, Geldrop (NL); Aleksandra Tesanovic, Eindhoven (NL); Mariana Nikolova-Simons, Bolton, MA (US); Kevin Michael Geary, Lynnfield, MA (US)

(73) Assignee: KONINKLIJKE PHILIPS N.V., EINDHOVEN (NL)

(21) Appl. No.: 14/368,412

(22) PCT Filed: Dec. 21, 2012
(86) PCT No.: PCT/IB2012/057630

§ 371 Date: Jun. 24, 2014

Related U.S. Application Data
(60) Provisional application No. 61/508,528, filed on Jul. 15, 2011.

(51) Int. Cl. G06F 19/00

(52) U.S. Cl. CPC G06F 19/3431; G06F 19/345
USPC 705/3

(57) ABSTRACT

The exemplary embodiments are related to systems and methods for prioritizing risk models and suggesting services tailored to a patient profile according to an exemplary embodiment described herein. One embodiment relates to a method comprising retrieving risk model and parameter data from a risk database, retrieving hospital profile data from a records database, determining a recommendation value for the model and parameter data based on the hospital profile data, determining at least one recommended service for a patient based on the recommendation value, and outputting the at least one recommended service to a user.

In the field of health care, Clinical Decision Support (“CDS”) systems are interactive systems using computer software to assist physicians and other health professionals with decision-making tasks, such as determining diagnosis of patient data and selecting an appropriate treatment. For instance, a CDS system is capable of linking health observations with health knowledge to influence health choices by clinicians, thereby improving overall health care services.

There are strong financial and patient-related motivations for health care operations (e.g., hospitals, clinicians, etc.) to ensure reduction of patient readmission while complying with quality improvement programs. A vast amount of validated models exist that predict the risk of an adverse event. However these models have been derived in specific hospital settings and, by nature, often do not take into account the inter-hospital differences. These differences may include hospital population criteria, predicting outcomes , parameters routinely collected at clinical practice, follow-up periods, etc. Therefore, it is difficult for hospitals and clinics to select a model that can best be used to manage desired outcomes, e.g., hospital readmissions and/or mortality. Furthermore, risk assessment and service selection within a hospital at discharge is of low value if no action is taken to reduce risk when the patient leaves the hospital.

The exemplary embodiments are related to systems and methods for prioritizing risk models and suggesting services tailored to a patient profile according to an exemplary embodiment described herein. One embodiment relates to a method comprising retrieving risk model and parameter data from a risk database, retrieving hospital profile data from a records database, determining a recommendation value for the model and parameter data based on the hospital profile data, determining at least one recommended service for a patient based on the recommendation value, and outputting the at least one recommended service to a user.

A further embodiment relates to a system comprising a data retrieval component for retrieving risk model and parameter data from a risk database and retrieving hospital profile data from a records database, a processing component for determining a recommendation value for the model and parameter data based on the hospital profile data, and for determining at least one recommended service for a patient based on the recommendation value, and a graphical user interface (“GUI”) for outputting the at least one recommended service to a user.

A further embodiment relates to a non-transitory computer readable storage medium including a set of instructions that are executable by a processor, the set of instructions being operable at least to retrieve risk model and parameter data from a risk database, retrieve hospital profile data from a records database, determine a recommendation value for the model and parameter data based on the hospital profile data, determine at least one recommended service for a patient based on the recommendation value, and output the at least one recommended service to a user.

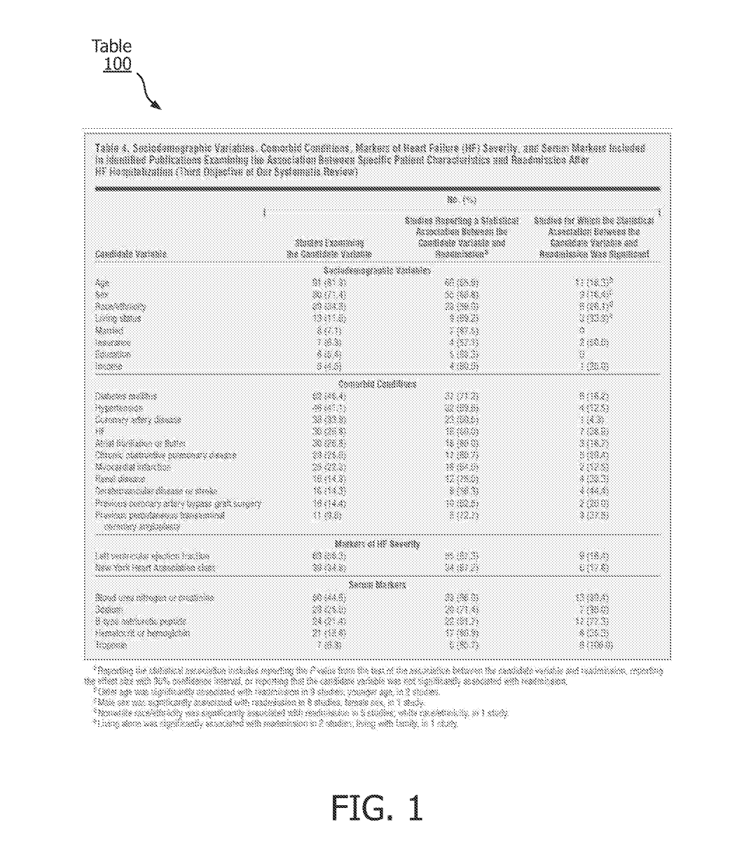

FIG. 1 shows an exemplary table of a plurality of statistical outcomes based on variables and conditions related to heart failure according to an exemplary embodiment described herein.

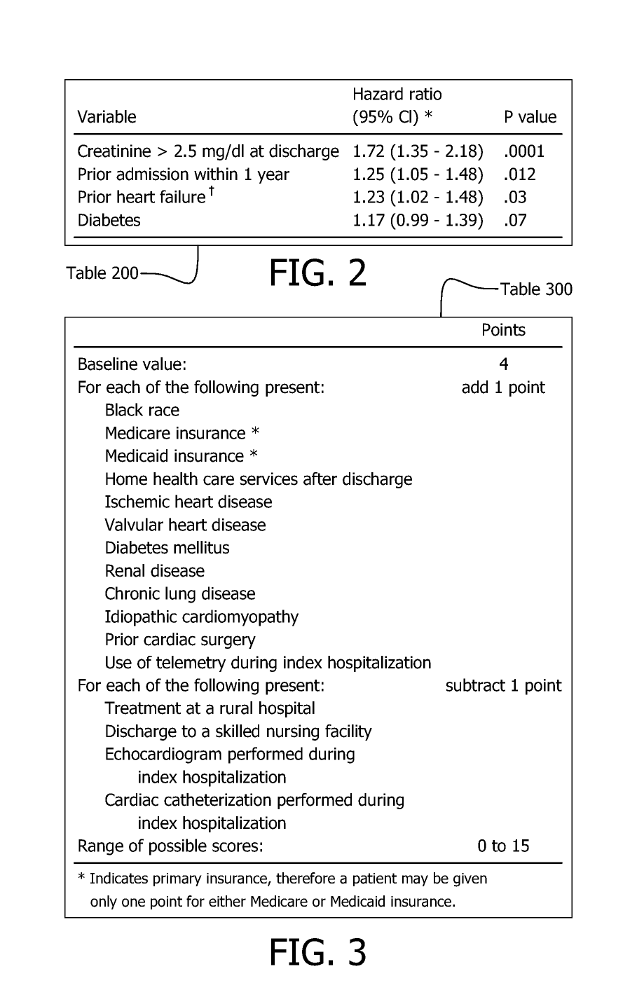

FIG. 2 shows an exemplary table of a plurality of parameters for a model predicting risk of all-cause readmission within 6 months according to an exemplary embodiment described herein.

FIG. 3 shows an exemplary table of a plurality of parameters for a model predicting risk of HF readmission within 1 year according to an exemplary embodiment described herein.

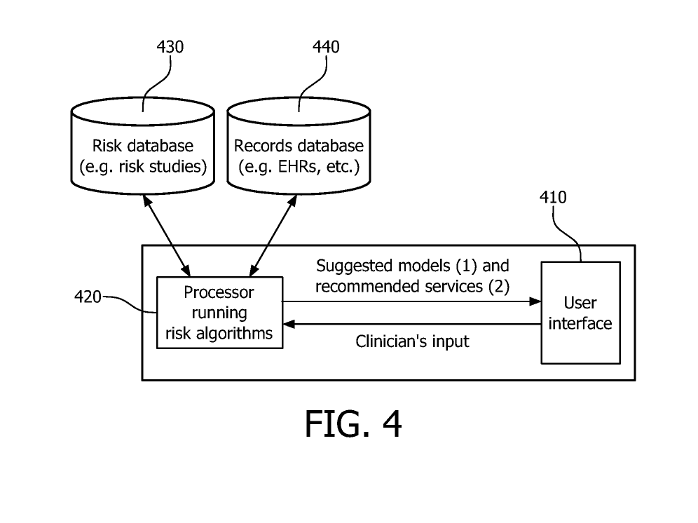

FIG. 4 shows an exemplary system for prioritizing risk models and suggesting services tailored to a patient profile according to an exemplary embodiment described herein.

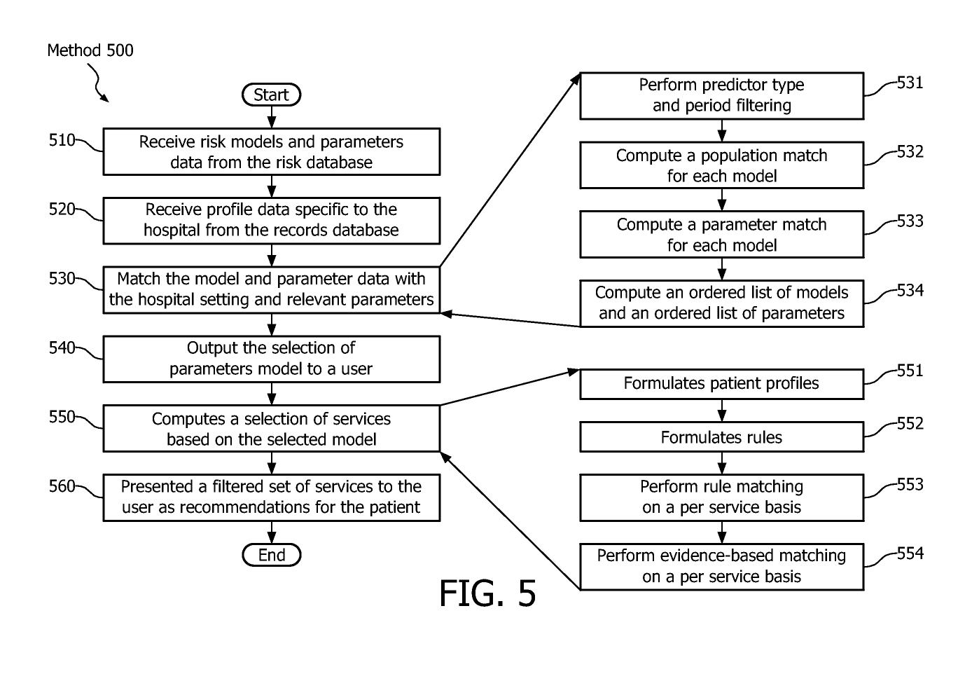

FIG. 5 shows an exemplary method for prioritizing risk models and suggesting services tailored to a patient profile according to an exemplary embodiment described herein.

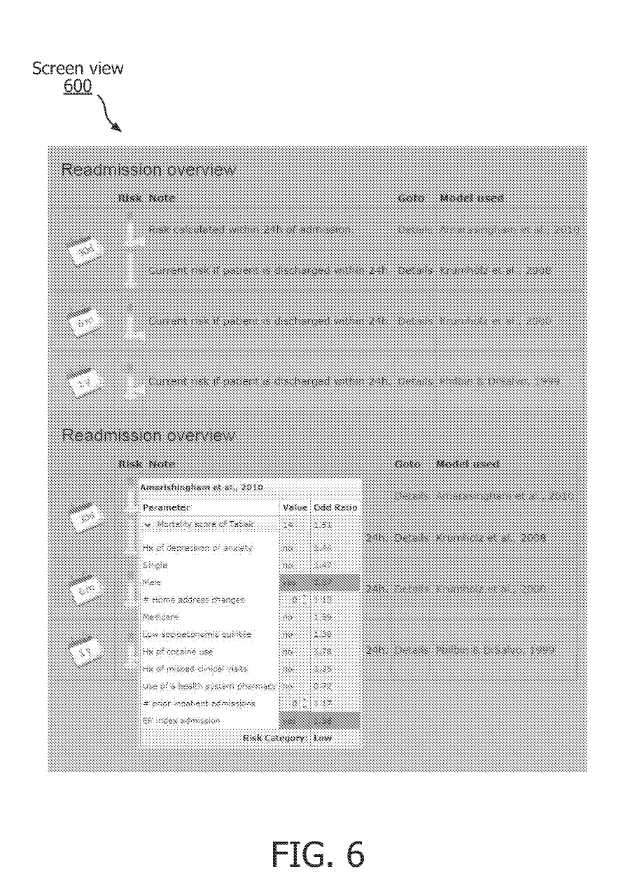

FIG. 6 shows an exemplary screen view for displaying a model and its parameters for selection by a user according to an exemplary embodiment described herein.

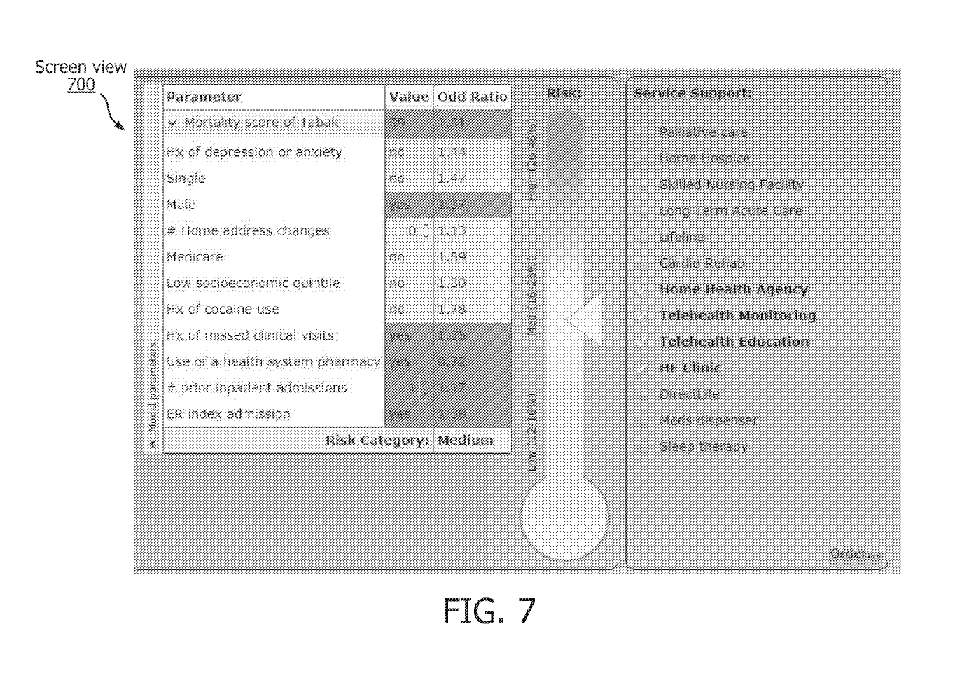

FIG. 7 shows an exemplary screen view of displaying the selected parameters, a risk score, and recommended services according to an exemplary embodiment described herein.

The exemplary embodiments may be further understood with reference to the following description of exemplary embodiments and the related appended drawings, wherein like elements are provided with the same reference numerals. The exemplary embodiments are related to systems and methods for prioritizing risk models and suggesting services tailored to a patient profile according to an exemplary embodiment described herein. For instance, the exemplary systems and methods for automatically suggesting combinations of out-hospital services based on the assessed mortality and/or readmission risk of a hospitalized patient.

As will be described in greater detail below, these exemplary systems and methods use meta-algorithms to select the risk parameters and models that best match a hospital profile. Accordingly, by combining the assessment of a risk stratification algorithm with a profile of a patient, the systems and methods suggest a tailored selection of out-hospital services.

Hospital readmission and mortality prediction are well-studied fields in the area of heart failure management. In these studies, patient characteristics are used to predict adverse health events after discharge from the hospital. In observational studies, parameters are collected during hospitalization, while the patients are monitored for a period of time after discharge. The parameters collected are a combination of psycho-social and clinical parameters and help describe various patient information, such as patient health status, health history, lifestyle, living circumstances, etc. These studies can focus on re-hospitalization, mortality, or both. Furthermore, these studies differ in the nature of the event addressed (e.g., focusing on Heart Failure events, general cardiac event or all cause events). For instance, a hospital interested in early readmissions may select a model that is developed to predict 30-day hospital readmissions, rather than one addressing all-cause readmission within a year.

In addition to the plurality of outcomes and follow-up periods addressed in these studies, the modeling parameters also demonstrate a wide range of variations between each of the conducted studies as indicated in an exemplary table 100 (Ross et al. 2008 model) of FIG. 1. Further, FIG. 1 shows a plurality of statistical outcomes based on variables and conditions related to heart failure according to an exemplary embodiment described herein. For example, the variations include: the time of assessment (e.g., blood values at admission or at discharge); the threshold values (e.g., ejection fraction <40% or <28%); the direction of the association (e.g., both male and female genders are found to be associated with early admissions.

According to the exemplary systems and methods described herein, one exemplary embodiment includes a risk evaluation system in the context of Clinical Decision Support (“CDS”) systems for heart failure management. This system effectively and efficiently assists clinicians throughout the discharge process to optimize the “Hospital-to-Home” cycle. The Hospital-to-Home cycle is a quality improvement initiative to reduce cardiovascular-related hospital readmissions and improve the transition from inpatient to outpatient status for individuals hospitalized with cardiovascular disease. Within this context, work is being conducted on evidence-based tools to assess the readmission risk of hospitalized heart failure patients. The systems and methods described herein can leverage upon the vast body of scientific studies on predictors of readmission and mortality for heart failure patients.

Accordingly, the exemplary risk algorithms are used to predict future adverse health events. Furthermore, the systems and methods can be used to tailor the care given to the patients as well as the services offered to the patients post-discharge.

It should be noted that while the embodiments discussed herein relate to patient heart failure conditions, one skilled in the art would understand that these exemplary systems and methods may be used in all fields of health care and cover a variety of medical conditions. Furthermore, in addition to providing value to cardiology information systems as a clinical decision component, the exemplary systems and methods may also be applicable for home health care solutions as it will enable effective selection of solution in home services, such as patient telemonitoring services, personal medical alert emergency response platforms, etc.

A wide range of parameters and thresholds are found to be associated with adverse events using univariate and multivariate analyses. Accordingly, the hazard or odds ratios for the diverse parameters also differ. Furthermore, the parameters contributing to the complete models may be quite different. Moreover, not all of the parameters are applicable within a broader setting. For instance, Medicaid insurance is only valid for U.S. health care system. Other parameters (e.g., biomarkers taken from blood samples, etc.) may not be collected in an everyday practice.

FIGS. 2 and 3 provide examples of existing models found in various studies. FIG. 2 shows an exemplary table 200 of a plurality of parameters for a model (Krumholz et al. 2000 model) predicting risk of all-cause readmission within 6 months according to an exemplary embodiment described herein. Each of the variables (e.g., creatinine levels, admission history, heart failure history, diabetes as co-morbidity, etc.) has an associated hazard ratio and “P” value. The hazard ratio expresses the difference between the adverse event rates of the two groups separated by the variable (e.g. the groups with creatinine levels above and below 2.5 mg/dL at discharge). The “P” value signals the statistical significance of the finding. Typically findings with “P” values below 0.05 or 0.01 are deemed to be significant.

FIG. 3 shows an exemplary table 300 of a plurality of parameters for a model (Philbin et al. 1999 model) predicting risk of HF readmission within 1 year according to an exemplary embodiment described herein. The risk score expressed in table 300 based on point summation corresponds to an increasing classification of risk (e.g., low, medium, high). For the classes, a range of readmission percentage is provided. For example, a low risk is associated with a readmission rate of 10%-20%.

Given the numerous predicting types, parameters and follow-up periods, it is difficult for a clinician to select a model that can best be used to manage the readmissions in his patient population (e.g., heart failure readmissions). To this end, the exemplary systems and methods can select a model, or combination of models, that fit the clinician and/or hospital for their patients. Furthermore, the risk assessment is of little value if the assessment cannot be somehow mitigated and reduced. For instance, a level of risk assessed in a hospital at discharge is of low value if no action is taken to reduce the level of risk when the patient leaves the hospital. Therefore, according to the exemplary embodiments described herein, risk assessments based on models are used to select a set of home-based services tailored to a specific patient. These tailored services may include, for example, activity monitoring, fall monitoring, education, remote patient monitoring, home nurse visits, skilled nursing facility, etc.

As will be described in greater detail below, the exemplary systems and methods allow for the selection of the best applicable predicting models and parameters. In addition, these exemplary systems and methods apply the model or combination of models to recommend a tailored selection of services for the patient after discharge.

FIG. 4 shows an exemplary system 400 for prioritizing risk models and suggesting services tailored to a patient profile according to an exemplary embodiment described herein. Specifically, the architecture of the system 400 includes a clinical graphical user interface tool 410 in communication with a processing component (e.g., processor 420), wherein the processing component runs a plurality of risk algorithms. It should be noted that while the processor 420 is illustrated as a separated component from the system 400, the processor 420 may also be integrated within the system 400 as an internal component. Furthermore, the system 400 may also include a database of risk studies (e.g., risk database 430) and a database of hospital medical records, or electronic health records (“EHR”) (e.g., records database 440). It should be noted that risk studies information can be gathered from any number of sources know in the art, such as, but not limited to, patient monitor systems, blood measurements and other system-based solution on or around the patient body.

According one exemplary embodiment, the algorithms utilized by processor 420 of the system 400 may include at least a model selection algorithm and a service recommendation algorithm. For model selection, the processor 420 retrieves a collection of risk stratification models and parameters from the risk database 430 as well as a profile of the hospital from the records database 440. Based on this input, the processor 420 uses the model selection algorithm to compute an ordered list of models and parameters as a function of relevance to the hospital's setting and the predictive power of the received models and parameters. Furthermore, the processor 420 uses the service recommendation algorithm to compute a selection of (out-hospital) services for the patient based on the sets of models and/or parameters selected to stratify adverse patient health events. The service recommendation algorithm uses risk outcomes, a patient profile, and properties formulated on corresponding relations. A collection of past combinations of risk outcomes and patient profiles is used in a learning algorithm to recommend services for current patients.

FIG. 5 shows an exemplary method 500 for prioritizing risk models and suggesting services tailored to a patient profile according to an exemplary embodiment described herein. It should be noted that method 500 will be discussed with reference to system 400 and related components of the system 400 illustrated in FIG. 4. As noted above, the collection of data and the subsequent computations are performed by the processor 420 of the system 400.

As detailed above, the system 400 allows for users (e.g., clinicians, hospital personnel, etc.) to improve risk assessment and service selection used in CDS systems. According to one of the exemplary embodiments, the system 400 is an add-on component to existing services, such as Philips Cardiovascular Information Management System, provided by Philips.

Using a library of models available to the system 400, the user is able to manually select one or more appropriate risk stratification models via the UI module 410 of the system 400. For instance, the selection of models may be based on: the type of risk addressed by the model (e.g., all-cause mortality, heart failure-specific readmission), the prediction period (e.g., 30 days, 3 or 6 months, 1 year), the match between available parameters and the required parameters for the model, the predictive power of the model (e.g., C-statistic or other indicators of a model's statistical strength), etc. For the user, this selection process may be a difficult and cumbersome task. Moreover, in an optimal situation, the patient population of the study matches the one addressed in the hospital.

FIG. 6 shows an exemplary screen view 600 for displaying a model and its parameters for selection by a user according to an exemplary embodiment described herein. Specifically, the screen view 600 is a display output of the system 400 where the user is invited to manually select an appropriate model through inspecting period and required parameters.

As discussed above, the model selection algorithm assists the user to automatically select appropriate models and/or parameters within the models to stratify the risk of adverse future events for a specific patient. Beginning with step 510, the system 400 receives a collection of risk stratification models and parameters from studies in the risk database 430. These exemplary studies are indexed as follows:
1. Outcome: all-cause/cardiac/HF-specific readmissions and/or all-cause/cardiac/HF-specific death.
2. The predicting or follow-up period.
3. Characteristics of the hospital(s).

a. Country

b. Rural/urban/academic

c. Other
4. Descriptive statistics of the population.

a. Number of patients

b. Demographics (age, gender, race, insurance, income, living status)

c. Inclusion/Exclusion Criteria

d. Cardiac/health status (e.g. co-morbidities, lab values)

e. Medical history (e.g. earlier readmissions, history of Acute Myocardial Infarction, etc.)

f. Length of hospital stay

g. Readmission and mortality rates
5. Predictors with

a. Cut-off values as identified in the study

b. Predictor Type (univariate/multivariate)

c. Hazard/Odds Ratio or other indicator of predictive power

d. Moment(s) of assessment
6. Model derived from these predictors with

a. The multi-parameter algorithm based on predictors mentioned under 5.

b. Outcome Risk Prediction score, which may be
i. A range (0-10, low-high), and/or
ii. Associated with percentages of the considered adverse event

c. Predictive power (C-Statistic or other indicator of model's statistical strength)

It should be noted that actual patient data is not expected to be available within the risk database 430. Instead, aggregated descriptive statistics are accumulated from available literature describing the corresponding study and the risk model derived from that study. For studies with all patient details available, the aggregated descriptive statistics can be automatically generated. The hospital and patient characteristics are aggregated numbers describing the whole population of the study.

In step 520, the system 400 receives profile data specific to the hospital from the records database 440. Apart from the characterization of a set of risk stratification studies, a characterization of the hospital in terms of the hospital's patient population (e.g., heart failure population) and routinely available patient parameters are provided by the records database 440. This exemplary hospital profile is indexed as follows:
1. Outcome(s) of interest for the hospital's setting.
2. Predicting period(s) of interest for the hospital.
3. Characteristics of the hospital(s)

a. Country

b. Rural/urban/academic

c. Other
4. Descriptive statistics of the hospital's population.

a. Number of patients

b. Demographics (age, gender, race, insurance, income, living status)

c. Cardiac/health status of the patients on the ward (e.g. common co-morbidities, lab values)

d. Medical history (e.g. earlier readmissions, history of AMI, etc.)

e. Common length of hospital stay

f. The hospital's (or cardiology ward's) readmission and mortality rates
5. All patient parameters assessed at routine basis, together with the moments of assessment (e.g. daily during hospitalization, at admission).

Using a dialog screen displayed by the risk system 400, the user is invited to specify these characteristics. To facilitate the indication of the available patient parameters at the hospital, a list of potential patient parameters is presented to the user. Alternatively, in step 520, this list is automatically generated by gathering all assessed parameters from the studies received in the risk database 430. The user can select subsets of parameters, as well as moments of assessing them, that is applicable for the user's practice.

In an alternative embodiment, the system 400 is connected to the hospital's EHR system. Using this link, parameters that are obtainable from the EMR can be automatically, or semi-automatically, retrieved and highlighted within the display (e.g., user interface 410) of the system 400.

In step 530, the system 400 matches the studies received from the risk database 430 with the hospital setting and relevant parameters. Specifically, the system 400 utilizes the model selection algorithm to assist the user in this matching process. Accordingly, the system 400 may determine a recommendation value, or score, for the model and parameter data based on the hospital profile data. The exemplary matching process includes population matching, parameter matching, predictor type and period filtering, and computation and presentation of ordered lists.

In sub-step 531, the system 400 performs predictor type and period filtering. Specifically, the system 400 filters out studies that do not match the stratification requirements as provided by the user. Studies with prediction types that are dissimilar to the one provided by the user are filtered out of the view. With respect to the predicting period, studies are discarded where the difference between the required period and the studied period are larger than a threshold as defined by the user. Accordingly, the system 400 resolves in a filtered view of all studies specific for the prediction period and type as relevant for the hospital.

In sub-step 532, the system 400 computes a population match for each of the studies within the risk database 430. Specifically, a match P(s,h) is calculated between each study ‘s’ and the hospital's characteristics ‘h’. This match, expressed in a range between 0 and 1, is calculated as the weighted distance between the normalized individual parameters. To this end, the hospital and population information of the study are expressed as a vector with feature values between 0 and 1. Continuous variables (e.g. average income, age, etc.) are scaled to a range from 0 to 1 using the minimum and maximum available values for these ranges. Textual parameters, such as the presence of co-morbidities, the hospital setting being rural or not, etc., are expressed as binary features, where 1 corresponds to the presence of the parameter, and 0 corresponds to its absence. In a similar fashion, a vector is created describing the hospital setting and patient population.

This results in two vectors s and h, where each feature sᵢ and hᵢ correspond to the same indicator (e.g. percentage of men in the population, normalized average hospital stay, etc.). Having two vectors describing hospital and study characteristics, we compute the distance P(s,h) between the two vectors. This distance is based on a standard distance measure from literature (e.g., Euclidian, Manhattan distance, etc.) and weights may be assigned to the individual parameters. These weights are provided by default in the system 400 and used by the algorithm. However, the user of the system 400 (e.g., a clinician) can adjust the order of the priorities of the features to stress the importance of certain features over others.

In sub-step 533, the system 400 computes a parameter match. Specifically, each of the studies is annotated with the predictive parameters and the parameters used in the presented models. Also, an overview of all parameters P is available in the hospital setting. For each study, the parameter and hospital setting are matched as follows.

for each [predictor p in study s] do {
if [p not in P] then remove p from view}

for each [model m in study] do {
for each [predictor p in m] do {
   if [p not in P] then remove from view {

}

If [no predictors and no models in view of s] then remove s from view

In an alternative embodiment, models that can be applied to parameter sets with missing data are highlighted. Based on the algorithm described above, these models may be presented together with the number of missing parameters for these models. In addition, the impact of the missing parameters (e.g., expressed as “HR” or “OR”) can be shown.

Using this selection algorithm, only the parameters that remain that match the parameters available in the hospital. Only the models remain of which all contributing parameters are available. Accordingly, the system 400 resolves in a filtered view of all studies specific for the parameters available in the hospital setting.

In sub-step 534, the system 400 computes two ordered lists. The first list is an ordered list of models as relevant for the user. This list gives a filtered view of relevant studies with a population match P(s,h). The system 400 scans all studies for the presences of models. This gives rise to collection models, each with a population match P(m,h) and a predictive value C(m). The weighted combination of the two is used to sort the order of the remaining models and present an ordered list.

The second list is an ordered list of parameters as relevant for the clinician. This list provides the user with a set of parameters including population match P(p,h). Each parameter is annotated with its predictive value C(p) and the strength of the predictor (e.g., univariate or multivariate, associated with a value between 0 and 1). In addition, the amount of times the parameter p occurs among the studies is used as a factor. Again, the weighted sum of these elements is now used to compute the ordered list of predicting parameters. When parameters occur multiple times in the list, all but the one with the highest score are removed from the list.

In step 540, the system 400 outputs the selection of parameters model to a user. Specifically, after running the model selection algorithm as described above, the system 400 provides a view of the most relevant parameters and models. The user is invited to select one or more parameters and models to be used to stratify patient risks. For the models, the associated outcomes are presented, while for the individual parameters a view is generated with an indication whether their values are favorable or not.

Furthermore, a percentage of the favorable parameters may be presented by the system 400. Alternatively, the user may formulate an independent aggregated risk score by selecting weights for the individual parameters. In others words, while this independent aggregated view may not be validated by the studies are used in the library (e.g., risk database 430), the view may be based on the user's experience or evidence collected from elsewhere. Furthermore, this independent view may be similar to screen view 600 of FIG. 6, where the readmission risk is communicated based on a model from literature.

In an alternative embodiment, the selection of parameters and models is done on the patient level rather than on the hospital level. In this case, the descriptors for the general patient population in the hospital are replaced with patient specific data. The algorithm is then executed with this patient specific data.

In step 550, the system 400 computes a selection of services based on the selected model of highest relevance. Having selected a set of risk parameters and models in step 530 and its sub-steps, the system 400 utilizes the service recommendation algorithm to recommend tailored out-hospital services for each of the patients. These out-hospital services may include, but are not limited to, at-home solutions such as Telehealth, cardio rehab, etc., as well as recommendation for admission at a nursing facility. The complete list of services can be configured by the hospital based on the local situation and availability of services. The exemplary system 400 focuses on the recommendation of a selection of services for an individual patient.

FIG. 7 shows an exemplary screen view 700 of displaying the selected parameters, a risk score, and recommended services according to an exemplary embodiment described herein. Specifically, the screen view 700 is a display output of the system 400 where the user is provided with a view of these services, risks and out-hospital recommendations.

Services are automatically selected based on three elements: the assessed readmission/mortality risk based on the aggregated risk score as described in the previous section; additional patient characteristics, which are relevant for the offering of services (e.g. medical history, financial situation, living arrangement, current usage of services, etc.); and a set of predefined rules describing the relations between risks, patient characteristics and services.

In sub-step 551, the system 400 formulates patient profiles. Specifically, the first two elements are combined into a patient profile, which can be expressed as a feature vector constituting of the following elements:

Values for each of the assessed parameters (e.g., favorable/unfavorable)

Outcome values for each of the models

The patient's demographics (e.g., age, gender, race, insurance, income, level of education, living status, etc.)

The patient's health parameters (e.g., symptoms, lab values, vitals, frailty, etc.)

Other social-psychological assessments of the patient, characterizing his cognitive and mental state and living circumstances

Medical history (e.g., earlier readmissions, co-morbidities, etc.)

Medications (e.g. medication history and current medications)

Length of hospital stay

Current out-patient services used

Computer literacy

In sub-step 552, the system 400 formulates rules. Specifically, the above-listed elements can be used to manually formulate rules in the system 400 to specify services for patients. For each of the services, a rule can be formulated to express the eligibility for the specific service. For example, the user can specify that the combination of the patient being “single” and a risk larger than 50% assessed by model A gives rise to a specific service ‘X.’

The user can specify a set of services that are excluded by the system 400 when suggesting the particular service. For instance, when recommending a skilled nursing facility, the recommendation of a range of at-home services may not be beneficial. By specifying services that mutually exclude each other, the list of recommended services will be better tailored to the user.

Having formulated the patient profiles and rules, the system 400 utilizes the service recommendation algorithm to automatically recommend services based on a patient profile. This algorithm uses a collection of past patient profiles, together with the services that have been selected for these patients. The algorithm consists of a two-step approach, that includes a rule matching and a evidence-based matching.

In sub-step 553, the system 400 performs rule matching. On a per service basis, the user has formulated rules describing which patient profiles should be selected for subscription. The service recommendation algorithm evaluates all these rules on the patient profile, which leads to a first selection of services S.

In sub-step 554, the system 400 performs evidence-based matching. An instance-based learning element of the algorithm (e.g., K-nearest neighbors) is applied to identify a set of similar patients in the patient population based on the given patient profile. The instance-based element compares the vectors of patient features and accordingly, recommends services to a patient based on services recommended to similar patients. Using K-nearest neighbors, the services recommended to a majority of the K most similar neighbors would be suggested using this portion of the algorithm. The instance-based learning element can retrieve a collection of services S′.

The system 400 merges the services S′ and S by taking their union. The rules defined on the mutual exclusion of the services are run on the joint collection of services. Thus, in step 560, this filtered set of services is presented to the user by the system 400 as recommendations for the patient.

It should be noted that the service recommendation algorithm can be implemented using both sub-steps 553 and 554, only step 553 or only step 554. In the latter two cases, the merging services S′ and S is to be excluded. Furthermore, the exemplary method 500 described above is merely an example of any number of steps performable by the system 400 and related components of the system 400. Accordingly, the system 400 is not limited to steps recited in exemplary method 500, and may perform additional steps or less steps than steps 510-560 and any of the respective sub-steps, and in any order.

According to the exemplary systems and methods described herein, the model selection phase may utilize input from the user or the hospital/clinic's EHR, or a combination thereof. This data acquisition phase can be fairly easy detected. With respect to the service recommendation portion, the usage of the system 400 can be detected in the configuration part. If opted for the learning approach, the usage of the system 400 can be detected by monitoring the recommended services over a period of time. An analysis of the collected data by the system 400 will reveal the usage of risk and patient parameters for the automatic recommendation of services.

Those skilled in the art will understand that the above-described exemplary embodiments may be implemented in any number of manners, including, as a separate software module, as a combination of hardware and software, etc. For example, the system 400 and related components may be a program containing lines of code stored on a non-transitory computer readable storage medium that, when compiled, may be executed on a processor. It should also be apparent from the above description that the exemplary embodiments allow the processing device to operate more efficiently when a user implements the system 400, e.g., by improving risk assessment for health care professionals, by automatically suggesting a combination of out-hospital services based on the assessed risks, by formulating a profile for each patient, by combining the assessment of risk with the profile of the patient to determine a tailored selection of these services, etc.

It is noted that the claims may include reference signs/numerals in accordance with PCT Rule 6.2(b). However, the present claims should not be considered to be limited to the exemplary embodiments corresponding to the reference signs/numerals.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

1. A method, comprising:
retrieving risk model and parameter data from a risk database;
retrieving hospital profile data from a records database;
determining a recommendation value for the model and parameter data based on the hospital profile data;
determining at least one recommended service for a patient based on the recommendation value; and
outputting the at least one recommended service to a user.

2. The method of claim 1, wherein determining a recommendation value includes computing a population match between the model and parameter data and the hospital profile data.

3. The method of claim 1, wherein determining a recommendation value includes computing a parameter match between the model and parameter data and the hospital profile data.

4. The method of claim 1, wherein determining a recommendation value includes filtering out model and parameter data based on one of predictor type information and predicting period information.

5. The method of claim 1, wherein determining at least one recommended service is further based on one of an assessed readmission risk and an assessed mortality risk.

6. The method of claim 1, wherein determining at least one recommended service is further based on a set of predefined rules describing a relationship between risks, services and patient data.

7. The method of claim 1, wherein determining at least one recommended service is based on at least one of:
rule matching between a patient profile and user selected rules; and
evidence-based matching between the patient profile and an identified set of a similar patients.

8. A system, comprising:
a data retrieval component for retrieving risk model and parameter data from a risk database and retrieving hospital profile data from a records database;
a processing component for determining a recommendation value for the model and parameter data based on the hospital profile data, and for determining at least one recommended service for a patient based on the recommendation value; and
a graphical user interface (“GUI”) for outputting the at least one recommended service to a user.

9. The system of claim 8, wherein determining a recommendation value includes computing a population match between the model and parameter data and the hospital profile data.

10. The system of claim 8, wherein determining a recommendation value includes computing a parameter match between the model and parameter data and the hospital profile data.

11. The system of claim 8, wherein determining a recommendation value includes filtering out model and parameter data based on one of predictor type information and predicting period information.

12. The system of claim 8, wherein determining at least one recommended service is further based on one of an assessed readmission risk and an assessed mortality risk.

13. The system of claim 8, wherein determining at least one recommended service is further based on a set of predefined rules describing a relationship between risks, services and patient data.

14. The system of claim 8, wherein determining at least one recommended service is based on at least one of:
rule matching between a patient profile and user selected rules; and
evidence-based matching between the patient profile and an identified set of a similar patients.

15. A non-transitory computer readable storage medium including a set of instructions that are executable by a processor, the set of instructions being operable at least to:
retrieve risk model and parameter data from a risk database;
retrieve hospital profile data from a records database;
determine a recommendation value for the model and parameter data based on the hospital profile data;
determine at least one recommended service for a patient based on the recommendation value; and
output the at least one recommended service to a user.

16. The non-transitory computer readable storage medium of claim 15, wherein determining a recommendation value includes computing a population match between the model and parameter data and the hospital profile data.

17. The non-transitory computer readable storage medium of claim 15, wherein determining a recommendation value includes computing a parameter match between the model and parameter data and the hospital profile data.

18. The non-transitory computer readable storage medium of claim 15, wherein determining a recommendation value includes filtering out model and parameter data based on one of predictor type information and predicting period information.

19. The non-transitory computer readable storage medium of claim 15, wherein determining at least one recommended service is further based on one of an assessed readmission risk and an assessed mortality risk.

20. The non-transitory computer readable storage medium of claim 15, wherein determining at least one recommended service is further based on a set of predefined rules describing a relationship between risks, services and patient data.
